(19) United States
(12) Patent Application Publication
(10) Pub. No.: US 2016/0055519 A1
(43) Pub. Date: Feb. 25, 2016

(54) APPORTIONING A MEDIA CAMPAIGN CONTRIBUTION TO A MEDIA CHANNEL IN THE PRESENCE OF AUDIENCE SATURATION

(71) Applicants: Anto Chittilappilly, Waltham, MA (US); Payman Sadegh, Alpharetta, GA (US); Darius Jose, Thrissur (IN)

(72) Inventors: Anto Chittilappilly, Waltham, MA (US); Payman Sadegh, Alpharetta, GA (US); Darius Jose, Thrissur (IN)

(21) Appl. No.: 14/465,838

(22) Filed: Aug. 22, 2014

(51) Int. Cl. G06Q 30/02

(52) U.S. Cl. CPC G06Q 30/0244

(57) ABSTRACT

A method, system, and computer program product for managing Internet advertising campaigns. Embodiments commence upon receiving (e.g., over a network) advertisement touchpoint data pertaining to a plurality of touchpoints. The advertisement touchpoint data comprises measured stimulation data (e.g., impressions) and measured response data (e.g., conversions). The stimulation data and response data is formatted into an initial succession of candidate touchpoint contribution values where each of the individual touchpoints contributes its respective portion of the total contribution from the total set of measured responses. A non-linear model is applied over the succession of candidate touchpoint contribution values to form a non-linear succession of candidate touchpoint contributions. Individual touchpoints receive an apportionment based on the non-linear succession of candidate touchpoint contributions. Non-linear successions of candidate touchpoint contributions can follow a non-linear diminishing returns curve such that later contributions by touchpoints are not over weighted. Compensation is calculated based on the fair apportionments.

### FIELD OF THE INVENTION

The disclosure relates to the field of managing an Internet advertising campaign and more particularly to techniques for considering audience saturation or other diminishing returns in a media campaign.

### BACKGROUND

Internet advertising has become ubiquitous. In the earliest days of Internet advertising, there were relatively few content providers, and even fewer of them were sophisticated enough to engage in a pay-for-placement advertising model. Today, there are hundreds of thousands of content providers, many of which do participate in a pay-for-placement advertising model. Today, even a modestly-sized Internet advertising campaign might involve many content providers (e.g., CNN.com, WSJ.com, Barrons.com, etc.) and any individual content provider might provide a large number of media channels and/or destinations and/or pages and/or other forms of impressions to engage an audience. Any of the aforementioned destinations or pages or other forms of impressions (e.g., touchpoints) can serve content in a form that permits placement of advertising messages on or near the content provided by the channel. A further discussion of touchpoints is disclosed in U.S. patent application Ser. No. 13/492,493, entitled “A Method and System For Determining Touchpoint Attribution” (Attorney Docket No. VISQ.P0001) filed on Jun. 8, 2012, the content of which is incorporated by reference in its entirety in this Application.

In many cases, an advertising message might be presented many times to the same audience (e.g., web visitors fitting certain target demographics), and in many cases, the same advertising message might be presented many times to the same individual. It has been observed that individuals within a targeted audience may be initially responsive to an advertising message, and may even be inspired (e.g., inspired toward further interest and/or action) and/or otherwise responsive to additional impressions of the same advertising messages. However, after some point (e.g., a point of saturation), still additional impressions to not inspire the individual to take additional responsive actions. Further impressions beyond this point begin to return less and less inspiration and/or become less effective to motivate the individual to pursue or act. Presenting still more and more impressions to the same user expends advertising dollars budgeted by the advertiser, yet those dollars expended do not return desired results. After the point of saturation, the placement of further impressions by a media channel exhibits diminishing returns for the advertiser, and the media channel should be compensated only to an extent that is commensurate with its contribution to desired results. In some cases, a particular touchpoint serves to place an advertising message to a particular user well after that particular user has already reached a point of saturation. In such a case, apportionment of contribution by that touchpoint as a portion of the total contribution should very small. Unfortunately, legacy techniques fail to account for saturation and/or fail to account for diminishing returns.

Techniques are needed address the problem of fairly apportioning compensation to a media channel. None of the aforementioned legacy approaches achieve the capabilities of the herein-disclosed techniques for considering diminishing returns in a media campaign. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for considering diminishing returns in a media campaign.

Some embodiments commence upon receiving (e.g., over a network), advertisement touchpoint data pertaining to a plurality of touchpoints. The advertisement touchpoint data comprises stimulation data (e.g., impressions) and response data (e.g., conversions). The stimulation data and response data is formatted into an initial succession of candidate touchpoint contribution values where each of the individual touchpoints contributes its respective portion of the total contribution to the measured set of responses. A non-linear model is applied over the succession of candidate touchpoint contribution values to form a non-linear succession of candidate touchpoint contributions. Individual touchpoints receive an apportionment based on the non-linear succession of candidate touchpoint contributions. The non-linear succession of candidate touchpoint contributions can follow a non-linear diminishing returns curve such that later contributions by touchpoints are not unfairly over weighted. Compensation is calculated based on the fair apportionments.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1 depicts an environment in which embodiments of the present disclosure can operate.

FIG. 2 depicts a state progression chart showing linear increases of a user's probability of conversion as the user progresses through states.

FIG. 3A depicts an engagement stack progression showing user progression through touchpoints, according to some embodiments.

FIG. 3B is a touchpoint attribute chart showing sample attributes associated with touchpoints of a media campaign, according to some embodiments.

FIG. 4A is a user propensity chart showing a linear user response trend, according to some embodiments.

FIG. 4B is a diminishing returns chart for modeling user behavior changes over time as used in systems for considering diminishing returns in a media campaign, according to some embodiments.

FIG. 5 depicts a state progression chart showing diminishing returns of user progressions over time as is used for considering diminishing returns in a media campaign, according to some embodiments.

FIG. 6 depicts a subsystem for apportioning compensation to a media channel as used in systems that consider diminishing returns, according to some embodiments.

FIG. 7 depicts a flow chart for selecting an apportionment model as used in systems that consider diminishing returns, according to some embodiments.

FIG. 8A is a diagram exemplifying diminishing returns in a media campaign, according to some embodiments.

FIG. 8B is a block diagram of a system for considering diminishing returns in a media campaign, according to some embodiments.

FIG. 9 is a block diagram of a system for considering diminishing returns in a media campaign, according to some embodiments.

FIG. 10 depicts a block diagram of an instance of a computer system suitable for implementing an embodiment of the present disclosure.

### DETAILED DESCRIPTION

### Overview

Internet advertising has become ubiquitous. In the earliest days of Internet advertising, there were relatively few content providers, and even fewer of them were sophisticated enough to engage in a pay-for-placement advertising model. Today, there are hundreds of thousands of content providers, many of which do participate in a pay-for-placement advertising model. Today, even a modestly-sized Internet advertising campaign might involve many content providers (e.g., CNN.com, WSJ.com, Barrons.com, etc.) and any individual content provider might provide a large number of media channels and/or destinations and/or pages and/or other forms of impressions to engage an audience. Any of the aforementioned destinations or pages or other forms of impressions (e.g., touchpoints) can serve content in a form that permits placement of advertising messages on or near the content provided by the channel.

In many cases, an advertising message might be presented many times to the same audience (e.g., web visitors fitting certain target demographics), and in many cases, the same advertising message might be presented many times to the same individual. It has been observed that individuals within a targeted audience may be initially responsive to an advertising message, and may even be inspired (e.g., inspired toward further interest and/or action) and/or otherwise responsive to additional impressions of the same advertising messages. However, after some point (e.g., a point of saturation) still additional impressions do not inspire the individual to take additional responsive actions. Further, impressions beyond this point begin to return less and less inspiration and/or become less effective to motivate the individual to pursue or act. Presenting still more and more impressions to the same user expends advertising dollars budgeted by the advertiser, yet those dollars expended do not return desired results. After the point of saturation, the placement of further impressions by a media channel exhibits diminishing returns for the advertiser, and the media channel should be compensated only to an extent that is commensurate with its contribution to desired results. In some cases, a particular touchpoint serves to place an advertising message to a particular user well after that particular user has already reached a point of saturation. In such a case, apportionment of contribution by that touchpoint as a portion of the total contribution should very small.

In exemplary cases, an Internet advertiser often uses many media channels through which the advertiser can place advertisements or other messages. A channel might host many touchpoints, any of which touchpoints can place an impression of an advertisement or message, possibly involving an advertisement server (ad server). The occurrence (e.g., impression) or other aspects related to the act of presentation of the impression (e.g., clicks) can be captured in a database. The captured data can include a source and timestamp (e.g., which channel and/or touchpoint was involved, and when), and the captured data can include an indication (e.g., a cookie) as to which individual audience member prompted the delivery of the captured impression. In some cases, data pertaining to a specific occurrence, timestamp, and meaning of a click can be captured in a database.

### Definitions

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

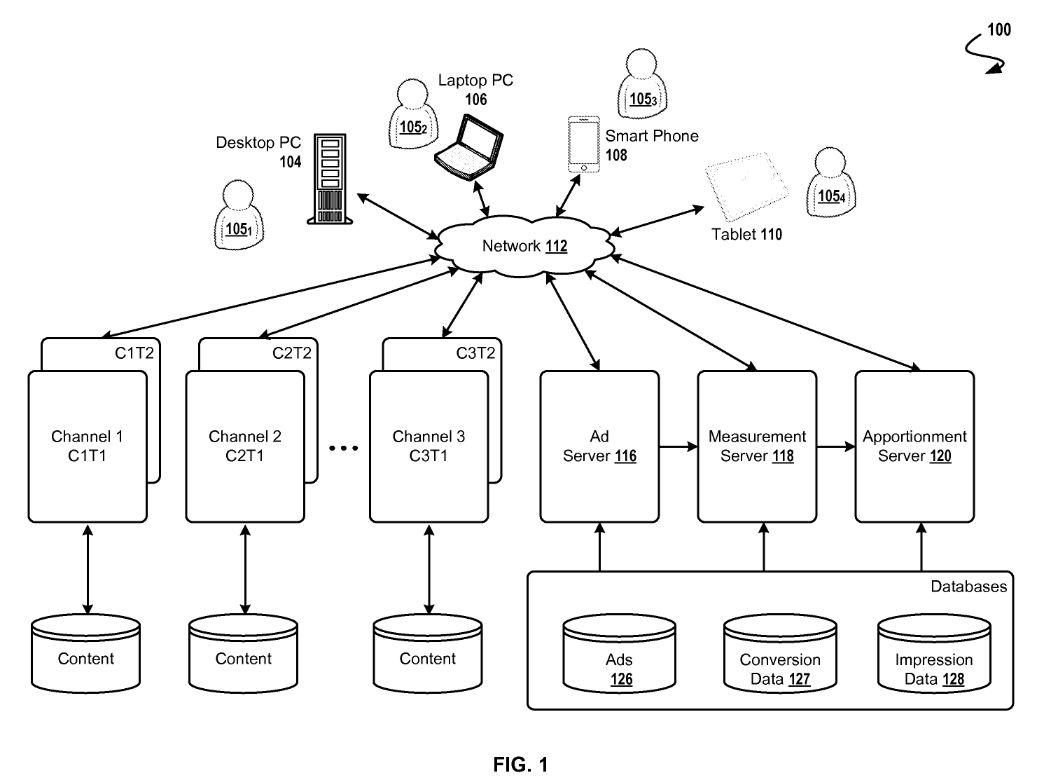

FIG. 1 depicts an environment 100 in which embodiments of the present disclosure can operate. The shown environment includes an audience (e.g., user 105₁, user 105₂, user 105₃, user 105₄, etc.), any of which users view content on a computing device (e.g., desktop PC 104, laptop PC 106, smart phone 108, tablet 110, etc.). The content can be provided by a content provider through any of a plurality of channels (e.g., channel1, channel2, etc.) and any channel may provide any number of touchpoints (e.g., web pages, pop-ups, etc.). The example environment shown in this diagram depicts three channels (e.g., channel1, channel2, channel 3) and, in this example, each channel presents multiple touchpoints each (e.g., C1T1, C1T2, C2T1, C2T2, C3T1 and C3T2). Any touchpoint can be configured so as to present an advertisement within or near the content of the touchpoint. More particularly, an ad server 116 can select a particular advertisement from a corpus of ads 126 (e.g., creative provided by an advertiser), and can generate an impression (e.g., content plus an advertisement) to be presented to a targeted user on their computing device.

According to one implementation, an ad server generates impressions, and sends the impressions content over network 112 to a computing device. A channel data provider can receive impression data via network 112. The collected data is stored in a database of impressions (e.g., impression data 127) and conversions (e.g., conversion data 128), which in turn is made accessible to a measurement server 118 and an apportionment server 120. Operations performed by a measurement server 118 and an apportionment server 120 can vary widely by embodiment. Several partitioning possibilities are discussed infra.

Network 112 may comprise any combination of networks including, without limitation, the web (i.e., the Internet), a local area network, a wide area network, a wireless network, a cellular network, etc. The network 112 includes signals comprising data and commands exchanged by and among the aforementioned computing devices and/or by channel servers, ad servers, measurement servers, and apportionment servers, as well as any intermediate hardware devices used to transmit the signals.

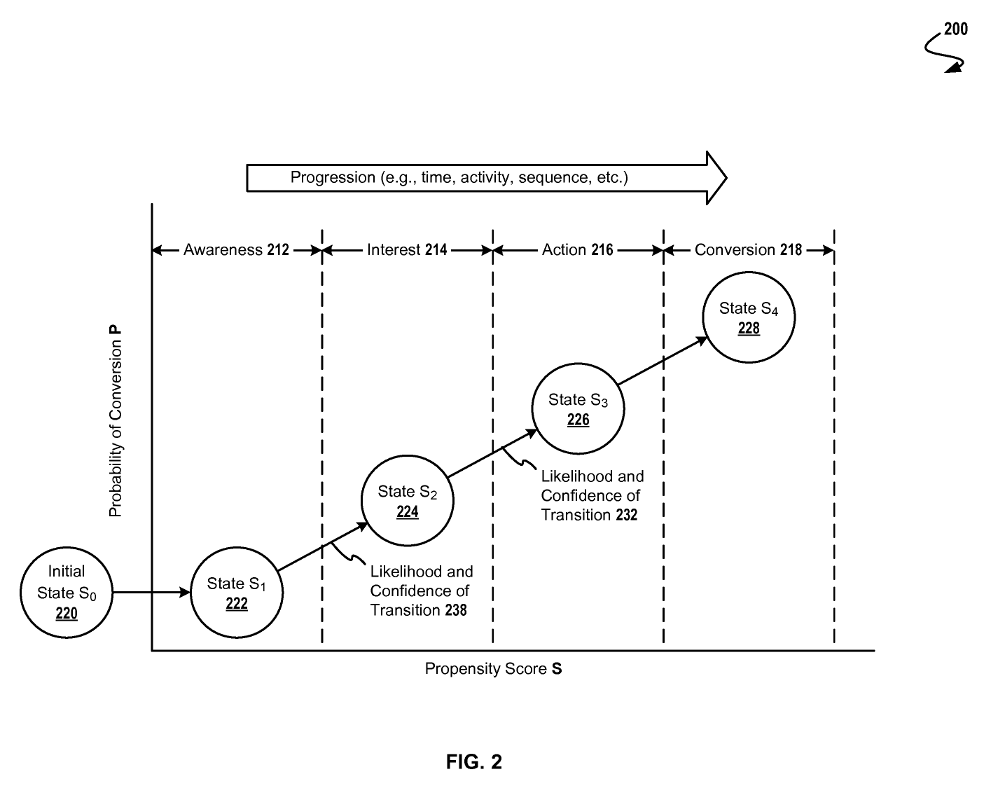

The foregoing environment serves to present adverting messages to a target audience. A particular user might receive several impressions, and responsive to seeing such impressions, the user might become more aware of the advertiser's messages and/or might take interest in the advertiser's message. With still more impressions, the user might be compelled to action (e.g., respond to a survey or peruse a product description), and in some cases a particular user reaches a decision point (e.g., to buy a product or subscribe to a service, or to otherwise “convert”). FIG. 2 depicts one possible progression of a user through several stages over time.

FIG. 2 depicts a state progression chart 200 showing linear increases of a user's probability of conversion as the user progresses through states. As an option, one or more instances of state progression chart 200 or any aspect thereof may be implemented in the context of the architecture and functionality of the embodiments described herein.

The chart 200 depicts a linear trend of a user's likelihood of conversion as a function of time. More specifically, the chart depicts a user's likelihood of conversion as a function of a time-wise progression through states (e.g., state S0 220, state S1 222, state S2 224, state S3 226, and state S4 228). As shown, the states correspond to user awareness 212, interest 214, and action 216, possibly including a conversion 218. The likelihood of conversion can be granular. For example, there can be a likelihood and confidence of a transition to interest state S2 (see transition 238) and/or there can be a likelihood and confidence of a transition to action state S3 (see transition 232).

A progression can be codified as a propensity score S (as shown). A series of propensity scores need not exhibit linear behaviors of probability of conversion over any particular progression range and/or between progression ranges. For example, while the shown state S3 has a linearly higher propensity score than state S2, a probability of conversion P corresponding to S3 might be only slightly higher than a propensity score corresponding to S2. Moreover, a state progression can be formulated for a particular user or for a particular set of demographics. A set of demographics (e.g., user-specific demographics pertaining to a particular user demographics pertaining to an aggregation of users) can be initially populated into an initial state S0 220.

An advertiser or media campaign manager might calibrate a propensity score and/or any of the constituents of a propensity score using a chart such as the depicted chart 200 and/or can calibrate a propensity score and/or any of the constituents of a propensity score using a series of observations over a series of engagements (e.g., progression through an engagement stack).

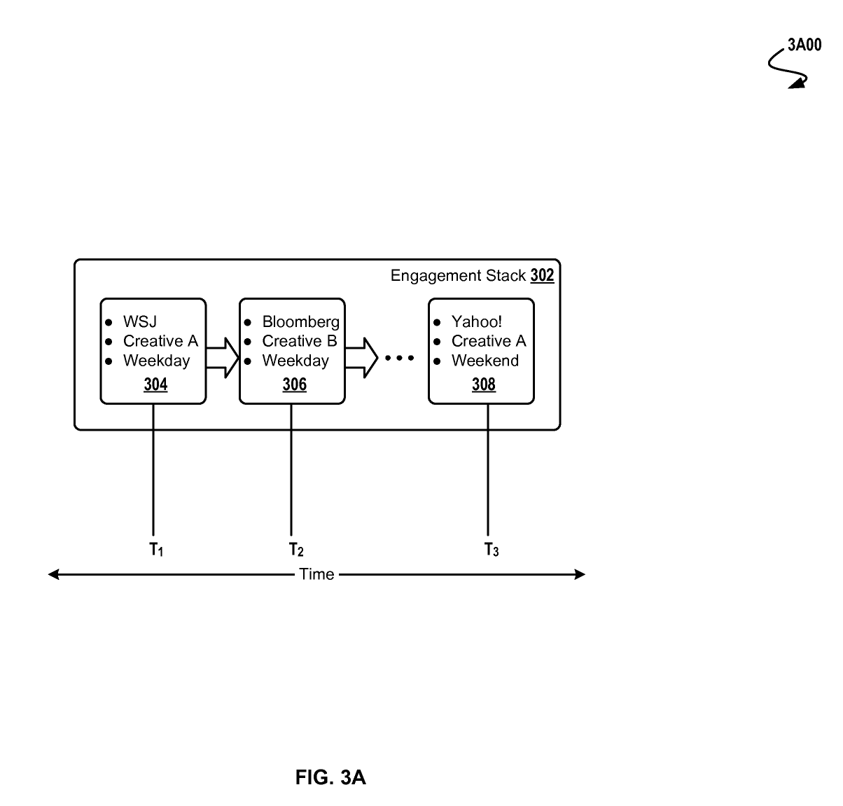

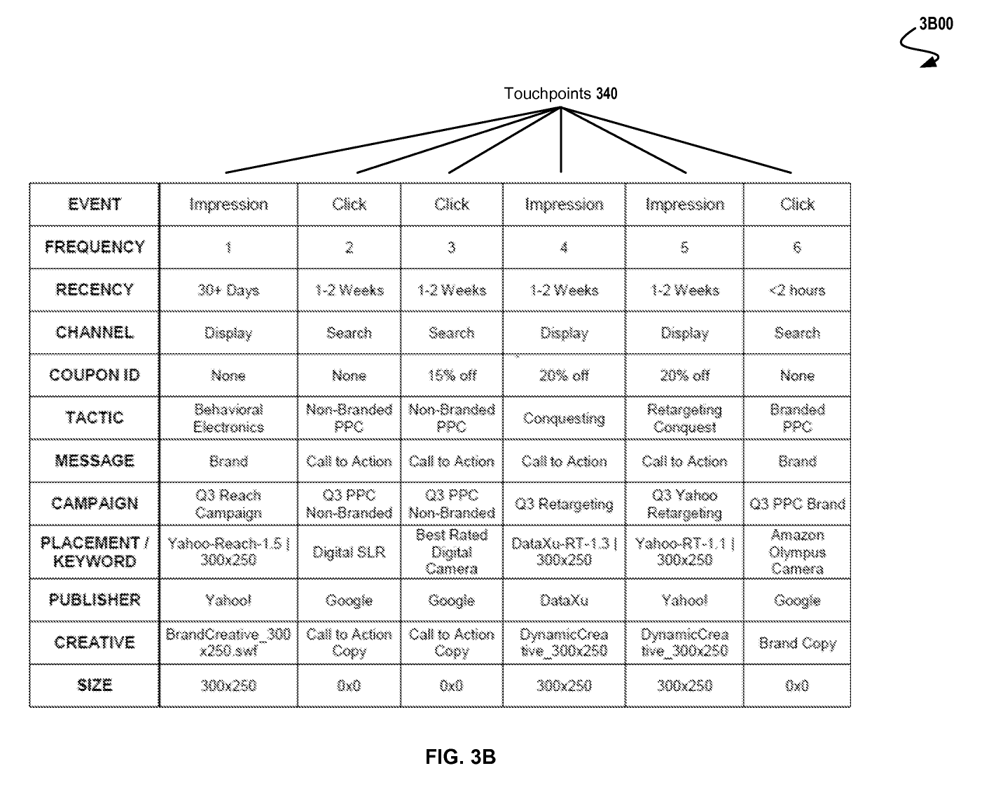

FIG. 3A depicts an engagement stack progression 3A00 showing user progression through touchpoints. As an option, one or more instances of engagement stack progression 3A00 or any aspect thereof may be implemented in the context of the architecture and functionality of the embodiments described herein. Also, the engagement stack progression 3A00 or any aspect thereof may be implemented in any desired environment.

The engagement stack 302 depicts a progression over time. As shown, the touchpoint comprising an online page of the Wall Street Journal (e.g., “WSJ”) includes an advertisement (e.g., “Creative A”) being displayed on a weekday 304. At some later moment, the touchpoint comprising an online page of the Bloomberg News (e.g., “Bloomberg”) includes an advertisement (e.g., “Creative B”) being displayed on a weekday 306. At yet another moment later in time, the touchpoint comprising an online page of Yahoo.com (e.g., “Yahoo!”) includes a second display impression of advertisement “Creative A”) being displayed on a weekend day 308. Any number of timestamped occurrences of these impressions and/or additional information (e.g., attributes) pertaining to the impression and/or user responses to the impression, are stored in an impressions and conversions database (see FIG. 1).

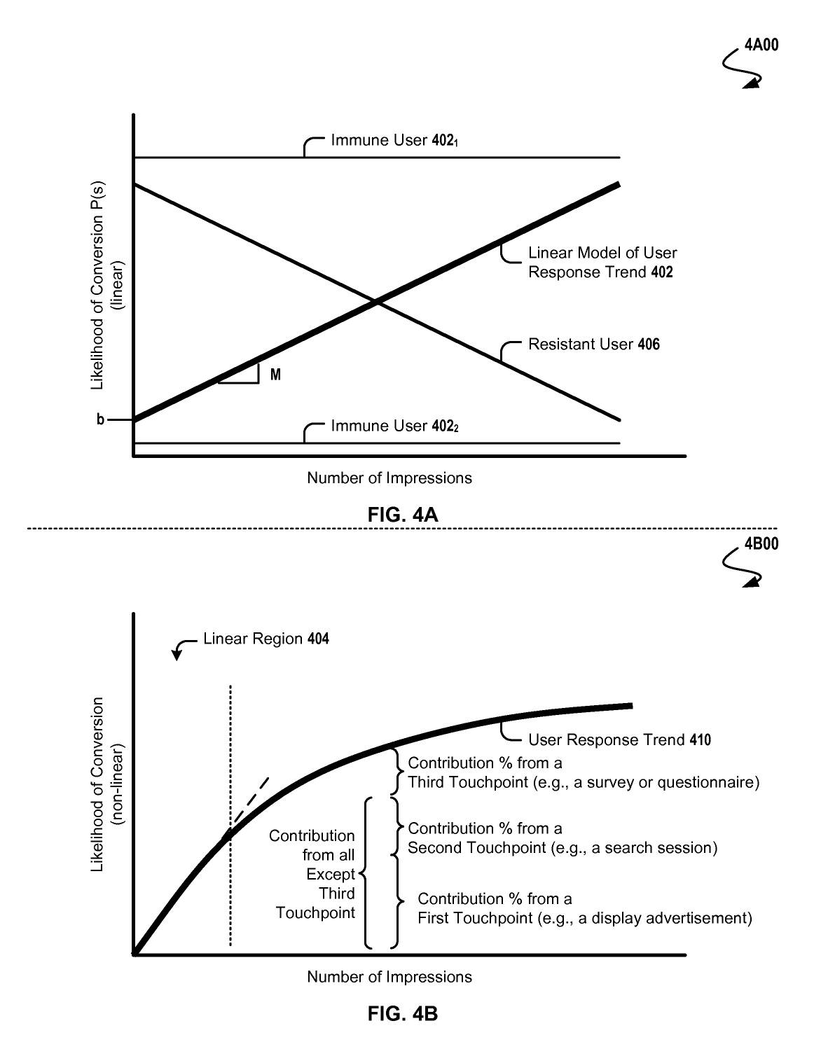

The timestamps can be used in later processing to characterize the progression with respect to the progression of time. In some cases the progression is substantially linear (e.g., see FIG. 4A), however in some cases the progression exhibits initially linear behavior, and then exhibits non-linear behavior (e.g., asymptotic behavior). In the depiction of FIG. 3A, the rate of impressions increases. As time progresses and as user behaviors are captured, certain attributes of touchpoints become more predictive as to user behavior while other attributes become less prevalent and/or less useful in making predictions. A selection of touchpoint attributes is presented in the following.

FIG. 3B is a touchpoint attribute chart 3B00 showing sample attributes associated with touchpoints of a media campaign. As an option, one or more instances of touchpoint attribute chart 3B00 or any aspect thereof may be implemented in the context of the architecture and functionality of the embodiments described herein. Also, the touchpoint attribute chart 3B00 or any aspect thereof may be implemented in any desired environment.

As discussed herein, a touchpoint can be embodied as an Internet destination or can be embodied as an event. In exemplary cases a touchpoint is any occurrence where a user and any aspect of a media campaign interact. In many of the systems discussed herein, there is a measurable relationship between a touchpoint and a conversion, and a media manager might use such measurements to make decisions as to channel spending and media mix etc. so as to increase the occurrence of conversions. In some cases a particular progression through touchpoints can be shown to be particularly effective to achieve some desired response (e.g., the user makes a “buy” decision). Indeed, the correlation of touchpoints to conversions and/or specific progressions through a set of touchpoints can be observed and analyzed for presentation to an advertiser or media manager. In many cases a particular progression through touchpoints can be shown to be particularly effective to achieve some desired response (e.g., the user makes a “buy” decision), and the correlation of touchpoints to conversions and/or specific progressions through a set of touchpoints can be observed and analyzed for the purpose of attributing performance of a touchpoint to achievement of desired responses.

FIG. 3B shows several touchpoints 340 associated with a conversion, and the touchpoints comprise one or more attributes. The example dataset of FIG. 3B correlates the various touchpoints with a plurality of attributes associated with respective touchpoints. Specifically, the leftmost column identifies the attribute, and columns 2-6 identify attribute values for attributes as pertains to various touchpoints. For example, the first attribute (“Frequency”) identifies the type of characteristic or event for the touchpoint. As shown, the first touchpoint (column 1) was an impression presented to the user, while the second and third touchpoints (columns 2 and 3) correspond to items the user clicked-on. Similarly, the other entries of the chart of FIG. 3B identify attribute values for the attributes of column 1 for the various touchpoints.

FIG. 4A is a user propensity chart 4A00 showing a linear user response trend 402. The chart depicts a resistant user 406, and immune users (e.g., immune user 402₁, and immune user 402₂). As depicted in the chart, different individual users respond differently to stimulation (e.g., stimulation from the set of touchpoints present in a particular engagement stack). For example, some users (e.g., immune user 402₁) will not click an ad, will not buy a product, and will not take action toward a particular advertiser objective—regardless of the nature or extent of stimulation (e.g., number of touchpoints, number of impressions, etc.). Conversely, some users (e.g., immune user 402₂) meet a particular advertiser objective (e.g., make a “buy” decision) regardless of the nature or extent of stimulation. Other users respond relatively favorably to additional stimulation (e.g., as the user traverses through the engagement stack), and still other users respond relatively unfavorably to additional stimulation (e.g., resistant user 406).

The behavior of a user vis-à-vis a number of touchpoint interactions and/or the number of delivered impressions and/or the behavior of a set of users in aggregate vis-à-vis number of delivered impressions, can be used to calibrate a media campaign. For example, the behavior of a user vis-à-vis a number of delivered impressions can be used in calculating a propensity score. In some cases, a situation of diminishing returns emerges. Such a point or region of diminishing returns can be depicted by plotting the likelihood of conversion as a function of aggregate touchpoint interactions or proxy therefrom (e.g., the number of impressions delivered) over an audience (e.g., an aggregation of users). The phenomenon of diminishing return is discussed as follows.

FIG. 4B is a diminishing returns chart 4B00 for modeling user behavior changes over time as used in systems for considering diminishing returns in a media campaign. The foregoing FIG. 4A shows how several touchpoint contributions to the likelihood of conversion over time can be modeled to form a linear contribution function. Many empirical observations of users over time indicate that a particular channel's contribution (e.g., a particular touchpoint's contribution) to conversion is only linear (or nearly linear) within some certain ranges (e.g., see the linear region 404) and then tapers off as the independent variable gets larger. This diminishing returns effect (e.g., saturation effect) of the contribution effect is depicted in the curve of FIG. 4B. A specific characterization of a user response trend 410 can be quantified and/or modeled as a mathematical equation or function to return a score. A representative set of observations shows that the conversion likelihood or score exhibits a diminishing return curve that is asymptotic to some upper bound.

The shown user response trend 410 has an inflection point beyond where the user's propensity to convert does not increase as fast as before reaching a region of saturation. In some cases, an advertising campaign manager would want to adjust the apportionment of the contribution to touchpoints that participate in the engagement stack, especially at points beyond the inflection point. The curve shown (see user response trend 410) and the point of inflection (or any other selected point) can be used to calibrate any models that calculate or use a propensity score.

Returning to the depiction of FIG. 4A, the propensity score can be given as a linear equation:

P(S)=M*S+b (1)

where P(S) is a propensity score, M is a slope, and b is an intercept.

The depiction of FIG. 4B is a substantially non-linear gradient. The propensity score can be given as:

$$Pgradient = \frac{P ( S ) - P ( S - Δ )}{P ( S )} \qquad ( 2 )$$

where P_{gradient} is the gradient score, and Δ is a small variation of S.

In exemplary embodiments, the value of Δ is established by removing the contribution of one of the touchpoints from the set of touchpoints from those modeled in the engagement stack. This process of removing one touchpoint at a time yields a quantitative measure of the contribution of the removed touchpoint. This process is repeated for the stack of touchpoints. When the contributions of each touchpoint are known (e.g., across a non-linear range), then each touchpoint can be fairly compensated based on the respective calculated contribution to the overall likelihood of conversion.

Strictly as an example, touchpoint contributions at some moment in time (as depicted in FIG. 4B), and the contributions of each touchpoint, can be calculated and codified into a table, such as is given in Table 1.

TABLE 1
Sample Contributions

| | Calculated Touchpoint | |
|---|---|---|
| | Contribution (e.g., using | Example form |
| Touchpoint | the gradient method) | of Contribution |
| Touchpoint1 | 45% | Presentation of a display |
| | | advertisement |
| Touchpoint2 | 30% | Engagement in a product |
| | | search activity |
| Touchpoint3 | 25% | Presentation of a consumer |
| | | review |
| Total | 100% | |

Gradient methods that use a form of EQ. 2 serve to fairly attribute contribution by participants in a media campaign (e.g., in an engagement stack or a touchpoint stack), at least inasmuch as gradient methods capture the phenomenon of diminishing returns. Methods to fairly apportion contributions by participants in a touchpoint stack can be used to manage channels and/or touchpoints in a media campaign.

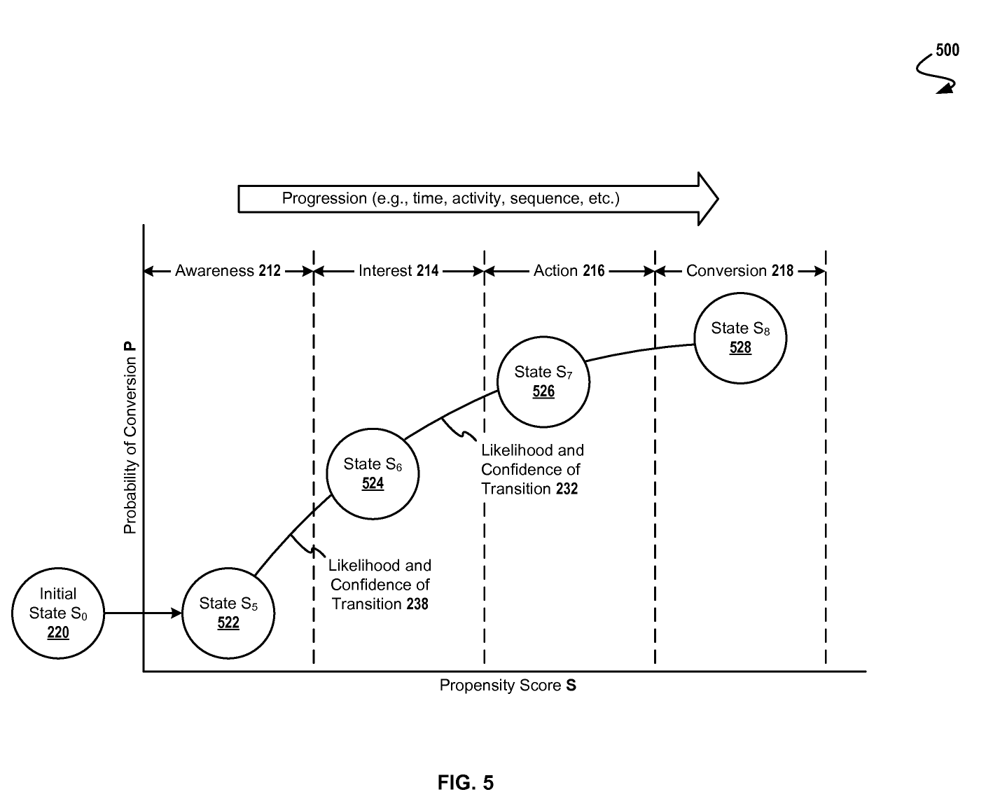

FIG. 5 depicts a state progression chart 500 showing diminishing returns of user progressions over time as is used for considering diminishing returns in a media campaign. The state progression chart 500 or any aspect thereof may be implemented in any desired environment.

The chart 500 depicts a user's likelihood of conversion as a function of time-wise progression. More specifically, the chart depicts a user's likelihood of conversion as a function of a time-wise progression through states (e.g., state S5 522, state S6 524, and state S7 526). As shown, the states correspond to user awareness 212, interest 214, and action 216. The likelihood of conversion increases over time, however the increase in the likelihood of conversion in later progression states increases more slowly as compared to increases in the likelihood of conversion in earlier states.

A likelihood of conversion can be codified as a propensity score. The curve of a trend of propensity scores over a progression (e.g., the curve from state S5 to state S8 528) follows a curved path that is asymptotic to a particular likelihood of conversion.

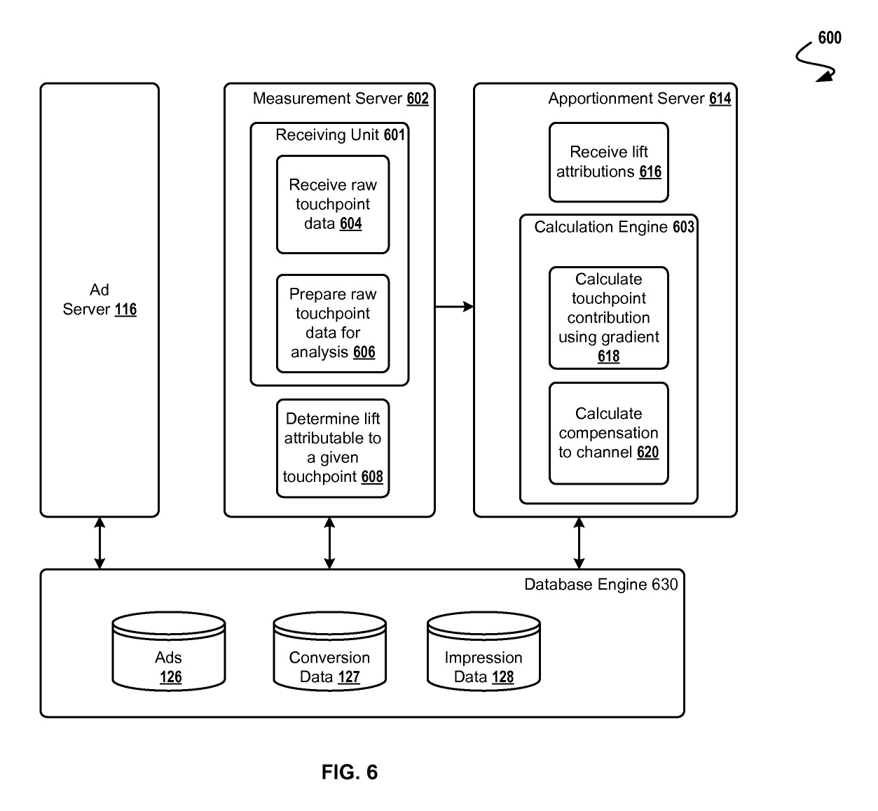

An advertiser or media campaign manager might want a propensity score to be calibrated or recalculated to follow such a curved model (e.g., a diminishing returns model). In some situations, a curve of a trend of propensity scores over a progression can be determined by evaluating empirical touchpoint data to determine the shape of the curve, and the curve can be used in turn to compensate a channel for their fair contribution within the engagement stack. Such a system is presented in FIG. 6.

FIG. 6 depicts a subsystem 600 for apportioning compensation to a media channel as used in systems that consider diminishing returns in a media campaign. As an option, one or more instances of subsystem 600 or any aspect thereof may be implemented in the context of the architecture and functionality of the embodiments described herein. Also, the subsystem 600 or any aspect thereof may be implemented in any desired environment.

A database of timestamped impression data (e.g., impression data 127) and a database of timestamped conversions (e.g., conversion data 128) can be analyzed by a computing node (e.g., measurement server 602) to take or calculate measurements such as an additional contribution (e.g., lift) provided by a touchpoint. As shown, the measurement server can receive raw touchpoint data (see operation 604), and such raw data can be prepared for various analysis (see operation 606). The prepared data can then be used to determine a value for the lift provided by or attributable to a given touchpoint (see operation 608).

In the context of a media campaign, system 600 can further serve to apportion a compensation amount for a channel. As shown, an apportionment server 614 can receive list attributions (see operation 616), and then the apportionment server can calculate touchpoint contributions using the gradient 618 (e.g., as determined by stacking the lifts as were calculated in the measurement server). The gradient, and the position of a set of touchpoints in a touchpoint stack, can be used to fairly apportion compensation to each contributor in the touchpoint stack (see operation 620).

The subsystem 600 presents merely one partitioning. The specific example shown where a measurement server 602 comprises a receiving unit 601 and where an apportionment server 614 comprises a calculation engine 603 is purely exemplary, and other partitioning is reasonable, and the partitioning may be defined in part by the volume of empirical data. In some cases a database engine 630 serves to perform calculations (e.g., within, or in conjunction with a database engine query).

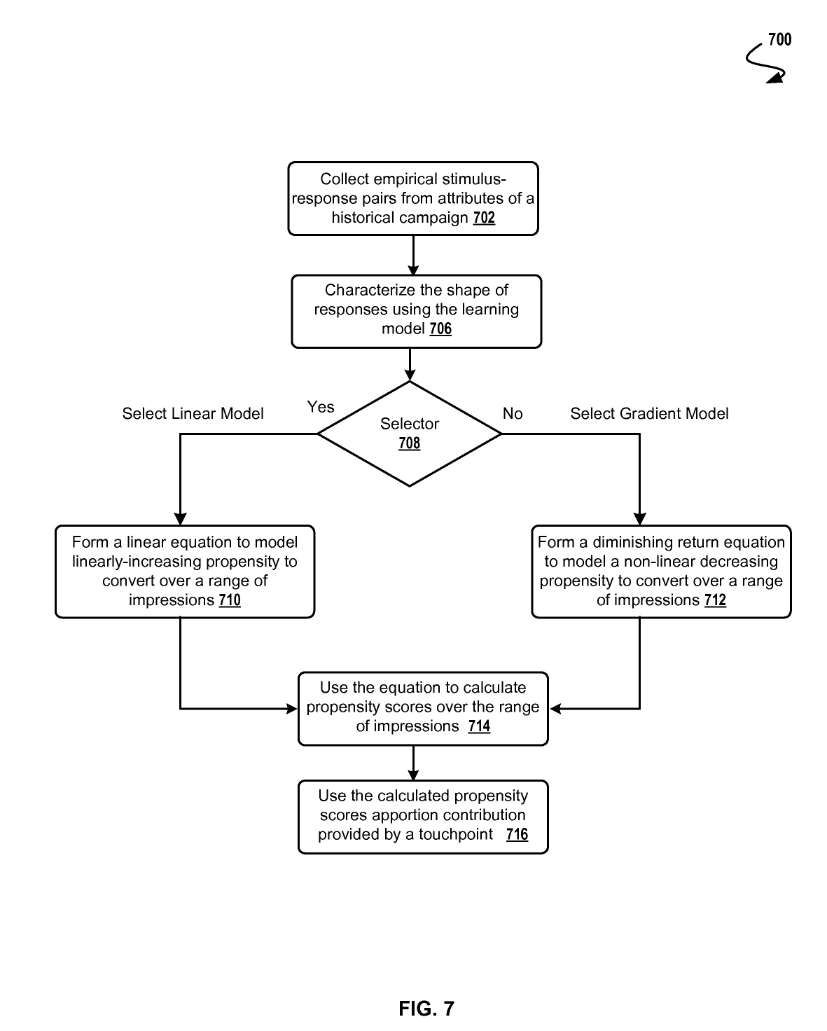

In some cases, there may be a paucity of empirical data; nevertheless, various techniques can be used to apply a gradient model so as to fairly apportion compensation to each contributor in the touchpoint stack. FIG. 7 depicts such a technique.

FIG. 7 depicts a flow chart 700 for selecting an apportionment model as used in systems that consider diminishing returns in a media campaign. As shown, empirical data is collected (see operation 702), and this data is analyzed to characterize the shape of the response (see operation 706). A selector 708 determines if the shape is a linear progression or if the shape is a curved shape. If the shape is more linear, then the linear branch is taken to select a linear model (e.g., a linear equation to apportion lift). If the shape is more consistent with diminishing returns, then the gradient branch is taken to select a gradient model (e.g., a gradient model to apportion lift).

The specific characteristics of the calculations provided in EQ. 1 and in EQ. 2 can be determined from the data. More specifically, the value of M in EQ. 1 can be determined empirically (see operation 710). Also, reasonable values of Δ can be determined from the empirically-collected data (see operation 712). Once a model has been selected, an equation with its coefficients and/or other determined characteristics can be used to calculate propensity scores over a range of impressions (see operation 714) and, in turn, the calculated propensity scores can be used to calculate an apportionment amount (e.g., to apportion an amount of lift) provided by a particular touchpoint (see operation 716).

### Additional Practical Application Examples

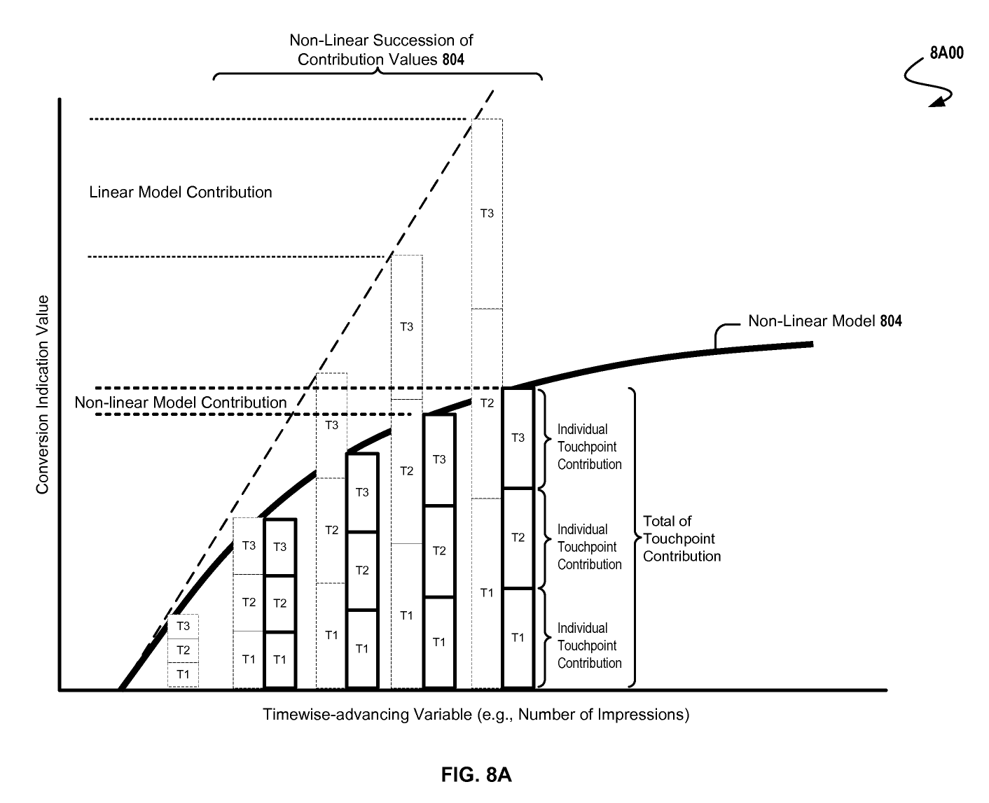

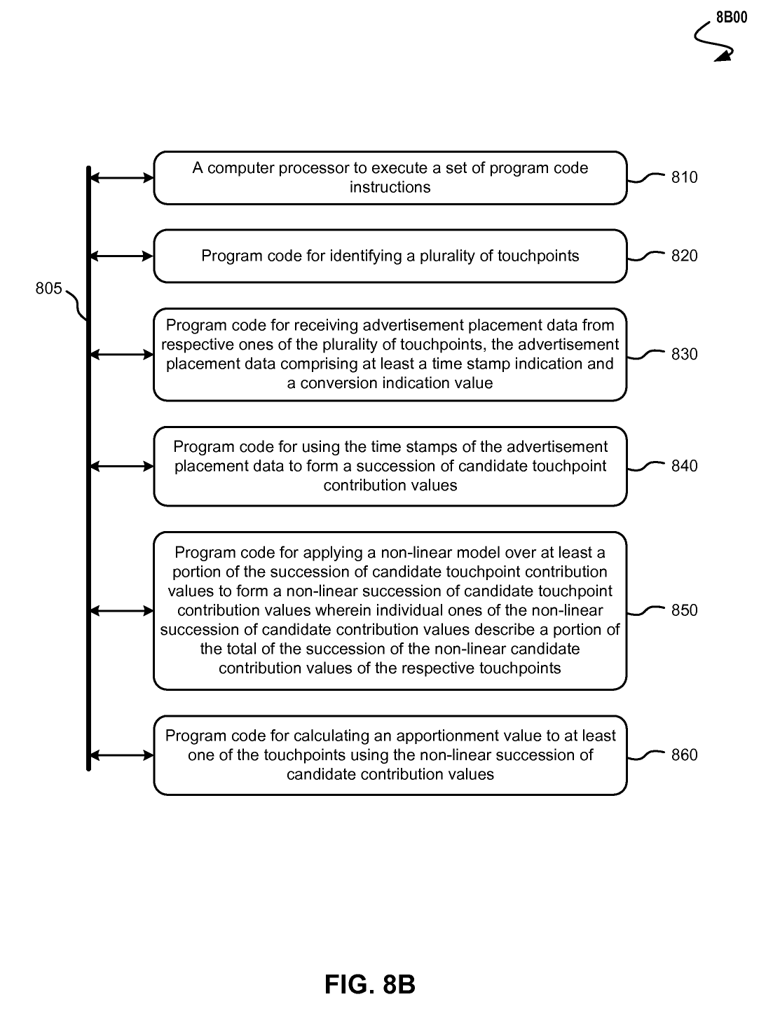

FIG. 8A is a diagram exemplifying diminishing returns in a media campaign. The diagram depicts stimulation data on the abscissa and response data on the ordinate. In this specific example, the stimulation is given as a timewise-advancing number of impressions, and the response data is characterized as a conversion indication value.

In this and other situations the stimulation data can come in the form of a measurement or measurements of exposure to a placement (e.g., impression) having a timestamp of exposure and a user ID (e.g., a cookie ID or other user ID) of the audience member who was exposed to a particular advertisement placement (e.g., from a particular touchpoint). For example, a stimulation data point might come in the form of “user ID1234 saw a display ad at yahoo.com on Jul. 6, 2015 at 8:32 am”.

In this and other situations the response data can come in the form of a measurement or measurements of conversions (e.g., a user action) having a time stamp of the conversion by a converter having a user ID. For example user ID1234 bought $1000 of goods on Aug. 7, 2014 at 3:44 pm.

Such stimulation and response data can be plotted. As shown, the diagram 8A00 identifies a plurality of touchpoints (see labels T1, T2, T3), then plots a succession of values from the identified touchpoints (e.g., advertisement placement data values, or data derived from touchpoint data such as a propensity score, etc.) across a timewise-advancing variable. The chart depicts results of applying a non-linear model 804 over at least a portion of the succession of values to form a non-linear succession of touchpoint contribution values. A change measured at the ordinate serves to apportion a contribution value to the measured touchpoint using the non-linear succession of candidate contribution values. As annotated on the diagram, strictly as one example, the change measured at the ordinate is measured using the last two candidate contribution values selected from the non-linear succession.

The results of any of the aforementioned operations, some of which results are depicted on the diagram of FIG. 4A, can be implemented in a computer-implemented system.

FIG. 8B is a block diagram of a system for considering diminishing returns in a media campaign. As shown, system 8B00 comprises at least one processor and at least one memory, the memory serving to store program instructions corresponding to the operations of the system.

As shown, an operation can be implemented in whole or in part using program instructions accessible by a module. The modules are connected to a communication path 805, and any operation can communicate with other operations over communication path 805. The modules of the system can, individually or in combination, perform method operations within system 8B00. Any operations performed within system 8B00 may be performed in any order unless as may be specified in the claims. The embodiment of FIG. 8A implements a portion of a computer system, shown as system 8B00, comprising a computer processor to execute a set of program code instructions (see module 810) and modules for accessing memory to hold program code instructions to perform: identifying a plurality of touchpoints (see module 820); receiving advertisement placement data from respective ones of the plurality of touchpoints, the advertisement placement data comprising at least a time stamp indication and a conversion indication value (see module 830); using the time stamps of the advertisement placement data to form a succession of candidate touchpoint contribution values (see module 840); applying a non-linear model over at least a portion of the succession of candidate touchpoint contribution values to form a non-linear succession of candidate touchpoint contribution values wherein individual ones of the non-linear succession of candidate contribution values describe a portion of the total of the succession of the non-linear candidate contribution values of the respective touchpoints (see module 850); and calculating an apportionment value to at least one of the touchpoints using the non-linear succession of candidate contribution values (see module 860).

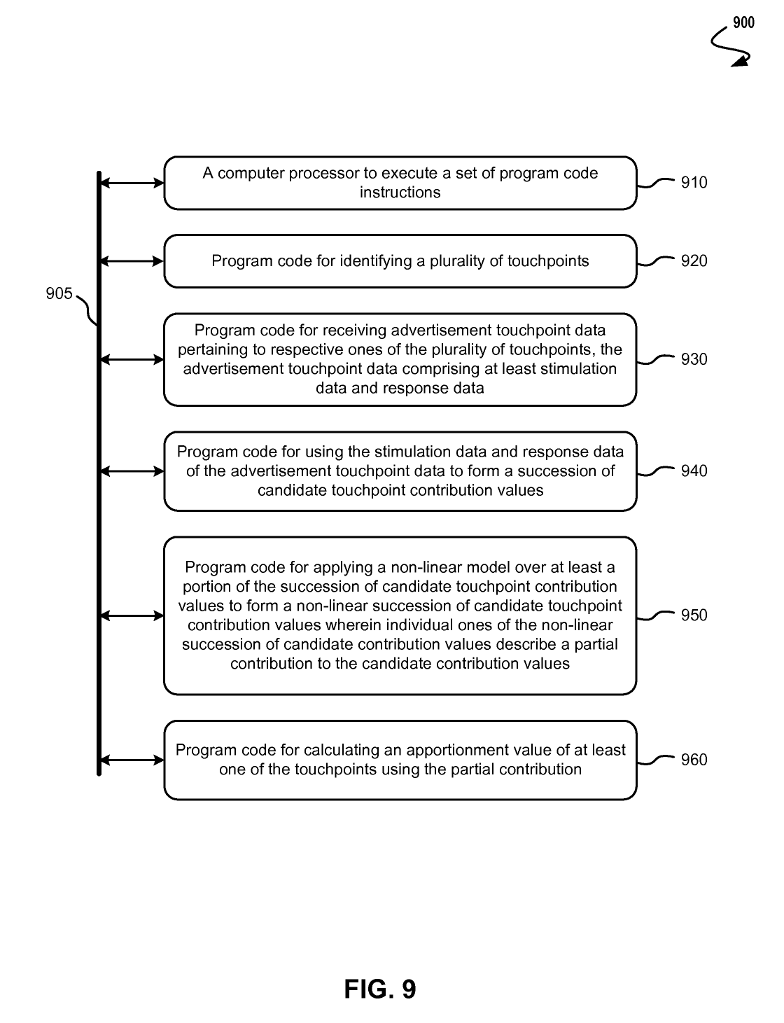

FIG. 9 is a block diagram of a system for considering diminishing returns in a media campaign. FIG. 9 depicts a block diagram of a system to perform certain functions of a computer system. As an option, the present system 900 may be implemented in the context of the architecture and functionality of the embodiments described herein. Of course, however, the system 900 or any operation therein may be carried out in any desired environment.

As shown, system 900 comprises at least one processor and at least one memory, the memory serving to store program instructions corresponding to the operations of the system. As shown, an operation can be implemented in whole or in part using program instructions accessible by a module. The modules are connected to a communication path 905, and any operation can communicate with other operations over communication path 905. The modules of the system can, individually or in combination, perform method operations within system 900. Any operations performed within system 900 may be performed in any order unless as may be specified in the claims. The embodiment of FIG. 9 implements a portion of a computer system, shown as system 900, comprising a computer processor to execute a set of program code instructions (see module 910) and modules for accessing memory to hold program code instructions to perform: identifying a plurality of touchpoints (see module 920); receiving advertisement touchpoint data pertaining to respective ones of the plurality of touchpoints, the advertisement touchpoint data comprising at least stimulation data and response data (see module 930); using the stimulation data and response data of the advertisement touchpoint data to form a succession of candidate touchpoint contribution values (see module 940); applying a non-linear model over at least a portion of the succession of candidate touchpoint contribution values to form a non-linear succession of candidate touchpoint contribution values wherein individual ones of the non-linear succession of candidate contribution values describe a partial contribution to the candidate contribution values (see module 950); and calculating an apportionment value of at least one of the touchpoints using the partial contribution (see module 960).

### Additional System Architecture Examples

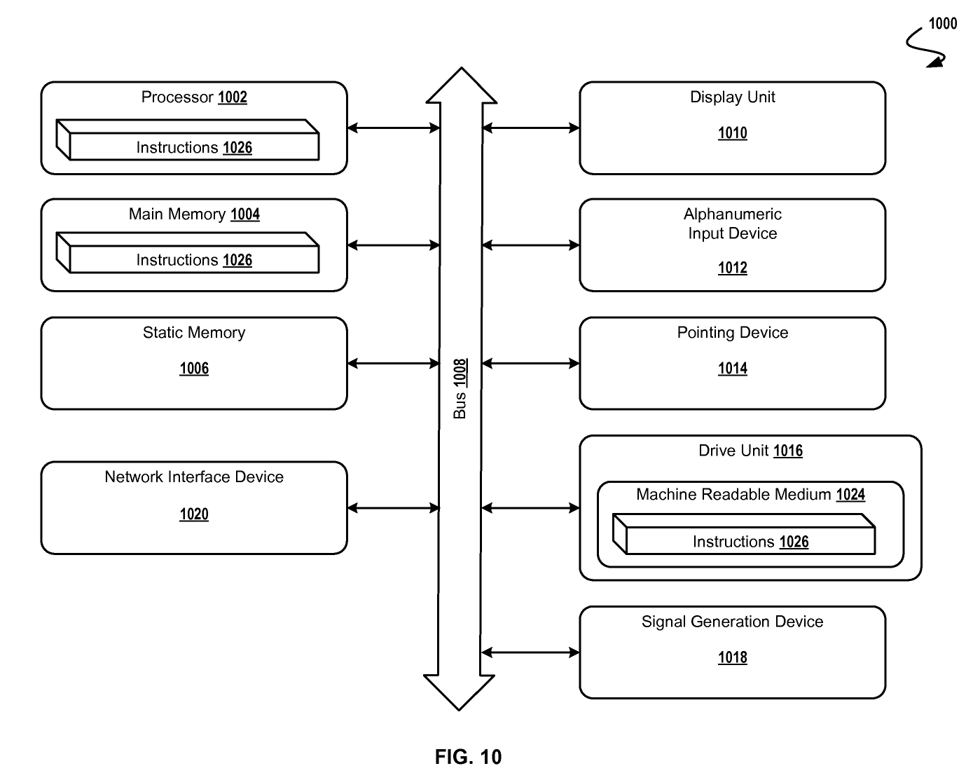

FIG. 10 depicts a diagrammatic representation of a machine in the exemplary form of a computer system 1000 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1000 includes a processor 1002, a main memory 1004 and a static memory 1006, which communicate with each other via a bus 1008. The computer system 1000 may further include a video display unit 1010 (e.g., an LED display, or a liquid crystal display (LCD) or a cathode ray tube (CRT)). The computer system 1000 also includes an alphanumeric input device 1012 (e.g., a keyboard), a pointing device 1014 (e.g., a mouse), a disk drive unit 1016, a signal generation device 1018 (e.g., a speaker), and a network interface device 1020.

The disk drive unit 1016 includes a machine-readable medium 1024 on which is stored a set of instructions 1026 (e.g., software) embodying any one, or all, of the methodologies described above. The instructions 1026 are also shown to reside, completely or at least partially, within the main memory 1004 and/or within the processor 1002. The instructions 1026 may further be transmitted or received via the network interface device 1020.

The computer system 1000 can be used to implement a client system and/or a server system and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as a processor 1002.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method comprising:
identifying a plurality of touchpoints;
receiving, over a network, advertisement touchpoint data pertaining to respective ones of the plurality of touchpoints, the advertisement touchpoint data comprising at least stimulation data and response data, wherein the stimulation data is formatted in a first data structure and the response data is formatted in a second data structure;
using the stimulation data and response data of the advertisement touchpoint data to form a succession of candidate touchpoint contribution values;
applying a non-linear model over at least a portion of the succession of candidate touchpoint contribution values to form a non-linear succession of candidate touchpoint contribution values wherein individual ones of the non-linear succession of candidate contribution values describe a partial contribution to the candidate contribution values; and
calculating an apportionment value of at least one of the touchpoints using the partial contribution.

2. The method of claim 1, wherein the first data structure and the second data structure comprise a third data structure.

3. The method of claim 1, wherein the apportionment value respective to a particular one of the touchpoints is calculated by determining a change based at least in part on a difference in values of a likelihood of conversion function.

4. The method of claim 3, wherein the likelihood of conversion function is a linear function to yield a propensity score P(S).

5. The method of claim 3, wherein the difference in values of likelihood of conversion function is determined by comparing a first likelihood of conversion function value to a second likelihood of conversion function value.

6. The method of claim 5, wherein the first likelihood of conversion function value is determined using a first set of touchpoints comprising the particular one of the touchpoints, and the second likelihood of conversion function value is determined using a second set of touchpoints that does not comprise the particular one of the touchpoints.

7. The method of claim 5, wherein the difference in values of likelihood of conversion function is determined by a formula
$${P}^{gradient} = \begin{matrix}P ( S ) - P ( S - Δ ) \\ P ( S )\end{matrix} .$$

8. The method of claim 5, wherein the value of Δ is the partial contribution to the candidate contribution values.

9. The method of claim 5, wherein the value of P(S) is a propensity score.

10. The method of claim 5, wherein the difference in values of likelihood of conversion is expressed as a percent.

11. A computer program product embodied in a non-transitory computer readable medium, the computer readable medium having stored thereon a sequence of instructions which, when executed by a processor causes the processor to execute a process, the process comprising:
identifying a plurality of touchpoints;
receiving, over a network, advertisement touchpoint data pertaining to respective ones of the plurality of touchpoints, the advertisement touchpoint data comprising at least stimulation data and response data, wherein the stimulation data is formatted in a first data structure and the response data is formatted in a second data structure;
using the stimulation data and response data of the advertisement touchpoint data to form a succession of candidate touchpoint contribution values;
applying a non-linear model over at least a portion of the succession of candidate touchpoint contribution values to form a non-linear succession of candidate touchpoint contribution values wherein individual ones of the non-linear succession of candidate contribution values describe a partial contribution to the candidate contribution values; and
calculating an apportionment value of at least one of the touchpoints using the partial contribution.

12. The computer program product of claim 11, wherein the apportionment value respective to a particular one of the touchpoints is calculated by determining a change based at least in part on a difference in values of a likelihood of conversion function.

13. The computer program product of claim 12, wherein the likelihood of conversion function is a linear function to yield a propensity score P(S).

14. The computer program product of claim 12, wherein the difference in values of likelihood of conversion function is determined by comparing a first likelihood of conversion function value to a second likelihood of conversion function value.

15. The computer program product of claim 14, wherein the first likelihood of conversion function value is determined using a first set of touchpoints comprising the particular one of the touchpoints, and the second likelihood of conversion function value is determined using a second set of touchpoints that does not comprise the particular one of the touchpoints.

16. The computer program product of claim 14, wherein the difference in values of likelihood of conversion function is determined by a formula
$$gradient = \frac{P ( S ) - P ( S - Δ )}{P ( S )} .$$

17. The computer program product of claim 15, wherein the value of Δ is the partial contribution to the candidate contribution values.

18. The computer program product of claim 15, wherein the difference in values of likelihood of conversion is expressed as a percent.

19. A computer system comprising:
a measurement server to identify a plurality of touchpoints;
a receiving unit to receive, over a network, advertisement touchpoint data pertaining to respective ones of the plurality of touchpoints, the advertisement touchpoint data comprising at least stimulation data and response data wherein the stimulation data and response data of the advertisement touchpoint data is used to form a succession of candidate touchpoint contribution values;
an apportionment server to apply a non-linear model over at least a portion of the succession of candidate touchpoint contribution values to form a non-linear succession of candidate touchpoint contribution values wherein individual ones of the non-linear succession of candidate contribution values describe a partial contribution to the candidate contribution values.

20. The computer system of claim 19, further comprising a calculation engine to calculate an apportionment value of at least one of the touchpoints using the partial contribution.
